(19) United States
(12) Patent Application Publication
(10) Pub. No.: US 2017/0246772 A1
(43) Pub. Date: Aug. 31, 2017

(54) METHOD OF MANUFACTURING INTEGRATED MODULAR STRUCTURE

(71) Applicant: KPIT Cummins Infosystems Limited, Pune (IN)

(72) Inventor: Vishal Pillai, Pune (IN)

(21) Appl. No.: 15/596,980

(22) Filed: May 16, 2017

Related U.S. Application Data
(63) Continuation of application No. PCT/IN2015/000411, filed on Nov. 6, 2015.

(30) Foreign Application Priority Data
Nov. 17, 2014 (IN) 3607/MUM/2014

(51) Int. Cl. B29C 41/06; B60R 16/02; B29C 33/12; B29C 41/20; B29C 41/38

(52) U.S. Cl. CPC B29C 41/06; B29C 41/20; B29C 41/38; B29C 33/12; B60R 16/0215; B29L 2031/3002

(57) ABSTRACT

The present invention discloses a method of manufacturing integrated modular structure using a rotomolding process. The method comprises preparing at least a pair of molds embedded with at least one electric harness, wherein the pair of molds having a base mold and a first mold joined to form an enclosure, filling a first material in the base mold of the pair of molds, providing a heating and cooling cycle, wherein during heating at least the pair of molds being rotated for evenly spreading the molten first material and embedding the electric harness in the molten first material, obtaining a first molded part yielded by at least the pair of molds, and obtaining a second molded part yielded by at least a pair of molds, thereby the first molded part, the second molded part and the at least one embedded electric harness together forming the integrated modular structure.

### CROSS-REFERENCE TO RELATED PATENT APPLICATIONS

This application is a Continuation of International Patent Application No. PCT/IN2015/000411, filed Nov. 6, 2015, which claims the benefit of and priority to Indian Patent Application No. 3607/MUM/2014, filed Nov. 17, 2014. The entire disclosures of the foregoing applications are hereby incorporated by reference herein.

### BACKGROUND

The present invention generally relates to a rotomolding process and more specifically relates to a process for manufacturing modular rotomolded structures and components.

In the recent years, the assembly processes in automobile industry have become quite time consuming and inefficient. The automotive body and chassis assembly process has evolved over the years to a stage where there is not much thought on changing the methodology of the process being set since years. Additionally, the current processes do not provide for modularity of the components making it difficult for assembling, integration and dissembling. Modularity is the degree to which a system's components may be separated and recombined. For example, the current automotive body assembly process consists of a Body in White (BIW) which could be a body on chassis or a monocoque construction. BIW refers to the stage in automotive design or automobile manufacturing in which the car body's sheet metal components have been welded together. The chassis is the underpart of a motor vehicle, consisting of a frame on which the body is mounted.

FIG. 1 is a block diagram illustrating a conventional process of assembly of a car body structure, according to the prior art. The BIW consists of six main assemblies majorly divided into front structure, two side body structures, floor structure, and roof structure. The panels which go into the sub assembly of these main assemblies get held in fixtures at weld stations and get welded together to form a closed section of metal. This provides the strength for taking up the load of the body aggregates and the payload of the vehicle.

The BIW is processed on the main assembly line which is supplied with the major panel's sub-assemblies. The sub-assemblies have flanges that help in interfacing with each other to assemble as a single body unit. The processes used as of today are welding, riveting or bonding with adhesives as per the set guidelines of assembly. The BIW is either welded or riveted or bolted to the chassis.

Further, it is painted by a process which involves immersion coating processes, paint curing processes, under-body sealant application, polyvinyl chloride (PVC) and wax applications, and painting spray booths operations. The painted body is then fitted with the sub-components like engine, suspensions brakes and tires. Also, electrical harnesses are fitted on the body panels with the help of either clamps or tie straps as per the requirement. The electrical harness is routed through the main subassemblies of the body. This body is then trimmed on the trim chassis final assembly line.

The existing solutions in rotation molding disclose about the use of reinforcements in metal and structural foam filling between the walls of the rotomolded component. This is to provide strength to the structure. They also have multilayer material, which are inseparable or non-modular. This is mainly to cater to different chemical characteristics required by application. The rotomolding leads to increase in strength by use of reinforcements and use of structural foam. The process in itself has the potential to combine many functional parts into one.

However, the use of foam for strengthening of structure is not always reliable as we are not able to predict the exact strength of the structure which gets molded, because the introduction of foam and its curing is process dependent. There is a need felt for using a material whose strength characteristics can be predetermined. It could be increased or decreased depending on the application. Also, it should be lighter than steel or aluminum which are currently used as reinforcements.

All the above conventional processes add to the cost and time of assembly, which could be reduced by using process of rotomolding. Therefore, there is a need for a method of manufacturing integrated modular structure using rotomolding process, which is optimal in terms of cost, assembly time and provides for ease of component integration. Additionally, the electric harness does not required to be replaced unless there is a damage which is mainly caused due to tampering of the harness by user. Therefore, there is also a need for a method by which the electric harness is embedded into the base structure.

### SUMMARY

An embodiment of the present invention describes a method of manufacturing integrated modular structure using rotomolding process. The method comprises preparing at least a pair of molds embedded with at least one electric harness, wherein the pair of mold having a base mold and a first mold joined to form an enclosure, filling a first material in the base mold of the pair of molds, providing a heating and cooling cycle, wherein during heating at least the pair of molds being rotated for evenly spreading the molten first material and embedding the electric harness in the molten first material, obtaining a first molded part yielded by at least the pair of molds, and obtaining a second molded part yielded by at least a pair of molds, wherein the pair of molds having the first molded part and a second mold part, thereby the first molded part, the second molded part and the at least one embedded electric harness together forming the integrated modular structure.

In one embodiment obtaining the second molded part comprises a) replacing the first mold with the second mold when the pair of molds is cooled to a predefined temperature, b) filling a second material between the second mold and the base mold, wherein the first molded part is in the base mold, c) providing a heating and cooling cycle to the pair of molds, wherein, during the heating of the second mold, the base mold is shielded to restrict melting of the first material, the second material heats up and melts causing the molten second material to spread within the pair of molds forming connection at edge of the modular structure, and d) obtaining the integrated modular structure with the harness being located at the center of the integrated modular structure section.

### BRIEF DESCRIPTION OF THE DRAWINGS

The aforementioned aspects and other features of the present invention will be explained in the following description, taken in conjunction with the accompanying drawings, wherein:

FIG. 1 is a block diagram illustrating a conventional process of assembly of a car body structure, according to the prior art.

FIG. 2 illustrates a block diagram of an assembly process for building a Body in White, according to an embodiment of the present invention.

FIG. 3 illustrates a sectional view of a mold set, according to an embodiment of the present invention.

FIG. 4 illustrates a sectional view of electric harness, according to an embodiment of the present invention.

FIG. 5 illustrates a method of holding the electric harness in the mold, according to an embodiment of the present invention.

FIG. 6 illustrates an electric harness being embedded in the wall of structure, according to an embodiment of the present invention.

FIG. 7 illustrates assembling of modular structures, according to an embodiment of the present invention.

FIG. 8 illustrates an electric harness having metal cover to embed at strategic locations in a structure, according to an embodiment of the present invention.

FIG. 9A illustrates modularity in connection of accessories or control devices to the electric harness, according to an embodiment of the present invention.

FIG. 9B illustrates a sectional view of modularity in connection of accessories or control devices to the electric harness, according to an embodiment of the present invention.

FIG. 10 illustrates cross-sectional view of a pillar designed to embed electric harness, according to an embodiment of the present invention.

FIGS. 11A-11C illustrates a method of manufacturing integrated modular structure using rotomolding process, according to an embodiment of the present invention.

FIG. 12 illustrates a carbon fiber cloth, according to an embodiment of the present invention.

FIG. 13 illustrates a flow diagram for a method for manufacturing integrated modular structure using rotomolding process, according to an embodiment of the present invention.

FIG. 14 illustrates a shape of tool to be replicated on the carbon fiber cloth, according to an embodiment of the present invention.

FIG. 15 illustrates a component of carbon fiber cloth with fastener that is held in the mold, according to an embodiment of the present invention.

FIG. 16 illustrates a carbon fiber cloth embedded in the modular structure, according to an embodiment of the present invention.

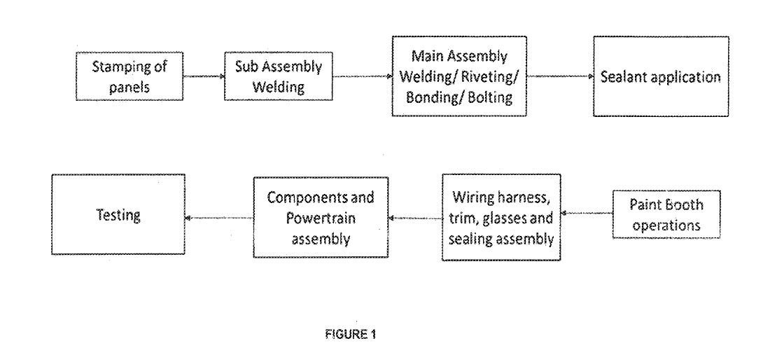

### DETAILED DESCRIPTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

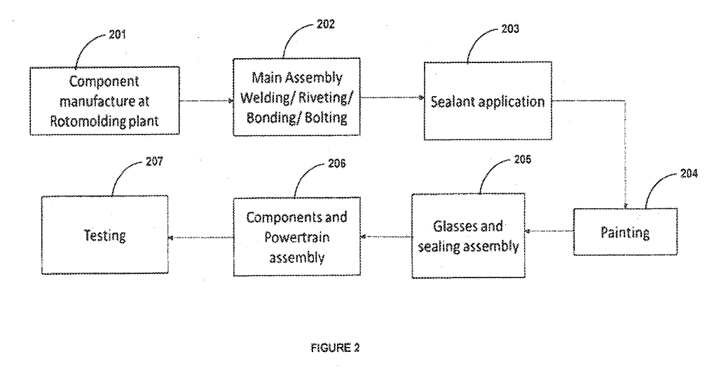

FIG. 2 illustrates a block diagram of an assembly process for building a Body in White, according to an embodiment of the present invention. According to the present invention, a simplified process for manufacturing an automotive body using rotomolding is disclosed. At step 201, components are manufactured at a rotomolding plant by using a method of the present invention. Once the components are manufactured, at step 202, the components undergo welding, riveting, bonding or bolting to form a main assembly. At step 203, a sealant is applied on the main assembly. After which, at step 204, the assembled main structure is painted. Further, at step 205, the painted main structure is assembled with glasses and also undergoes for sealing assembly. Finally, at step 206, the components and powertrain are assembled. At the end, at step 207, the final product undergoes testing. The present invention takes advantage of a closed section structure provided by rotomolding, which is stress free and joint free. In one embodiment, the carbon fiber cloth is embedded in the structure to provide additional strength to the modular structure.

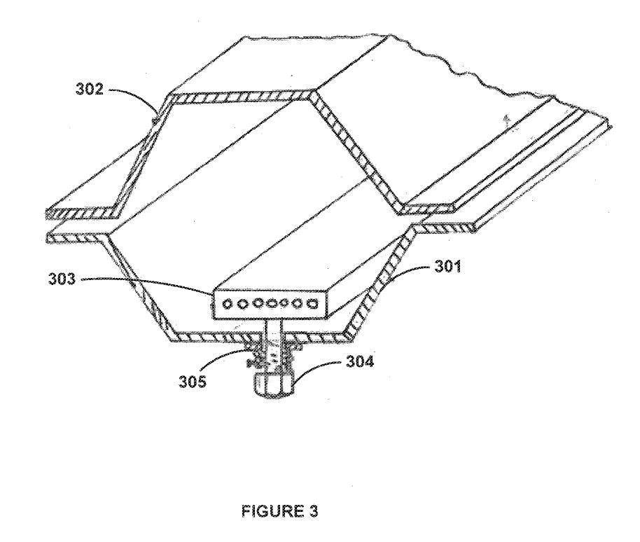

FIG. 3 illustrates a sectional view of a mold set, according to an embodiment of the present invention. In one embodiment, the mold set is made up of a base mold 301 and a first mold 302. The electric harness 303 is placed inside the mold set which is supported along the length. Further, the mold set is filled-in with a polymer powder in order to form a molded part/structure.

The electric harness 303 is flexible in structure and cannot be embedded in the mold as it will sway during rotation movement in the mold. To ensure that the electric harness 303 is embedded inside the structure being molded, it is necessary that the electric harness 303 does not move during the molding process. The movement of electric harness 303 does not allow the same to be centered in the structure, resulting in making the structure stronger in one portion while weaker in the other portion. Therefore, in order to avoid movement of the electric harness 303, one of the molds in the mold set has a screw 304 with spring 305 to hold the electric harness 303 in place. It is to be noted that any other method know in the art may be utilized to hold the electric harness 303 in place. As per the method of the invention, the electric harness is embedded well inside the structure and hence cannot be tampered with. Additionally, the harness does not burn or catch fire due to single coil wire and lack of exposure to oxygen. For prevention against over surge, a fuse may be provided or separate ground line may be provided in each structure. Hence, it is to be noted that the electric harness does not have to be replaced unless in case of extreme damage due an accident.

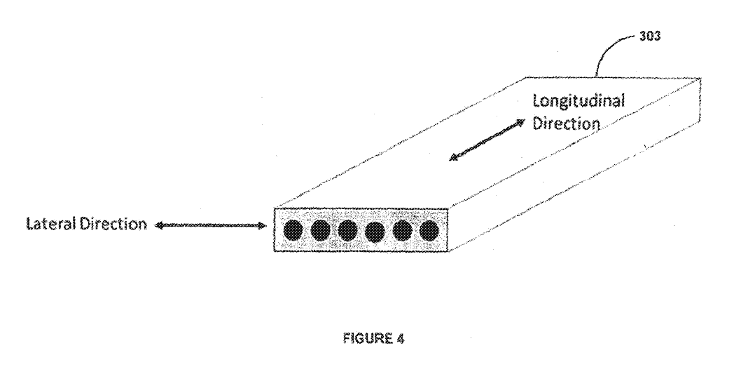

FIG. 4 illustrates a sectional view of electric harness 303, according to an embodiment of the present invention. The electric harness 303 is designed to have strength in the lateral direction as shown. This design protects the electric harness 303 when it is subjected to bending or swaying during the molding process.

According to an embodiment of the present invention, providing strength in the lateral direction of the electric harness 303 ensures that when the melted polymer powder flows onto the electric harness 303, it will not sway or deform due to the viscosity of the molten polymer. The electric harness 303 is supported at a length which does not exceed 100 mm. While bending the electric harness 303, the radius of bend depends upon the geometry of the harness. For example, if the thickness is more than 3 mm, the bend radius needs to be greater than 40 mm. This is to ensure that it is held firmly and does not sway due to the forces during the process.

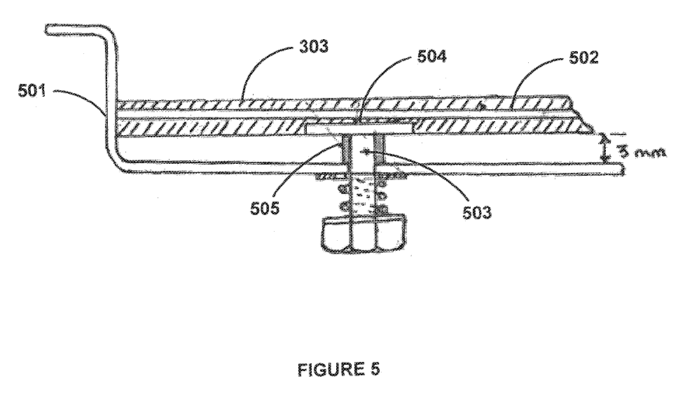

FIG. 5 illustrates a method of holding the electric harness in the mold, according to an embodiment of the present invention. There are various ways to separate the electric harness 303 from a mold face, while maintaining a gap of a minimum distance, 3 mm in one exemplary embodiment. In the exemplary embodiment, the electric harness 303 is maintained at a distance of 3 mm from the face of the mold so that it is not heated to the melting point. This particular gap ensures that the heat with which the mold is subjected to does not melt the electric harness 303 and also ensures that the molten polymer flows completely in between the electric harness 303 and the mold face. The distance of the electric harness 303 from the face of the mold also depends on the thickness of the material wall required. It is to be noted that 3 mm is only an exemplary distance and this distance would vary depending on the application.

According to one embodiment of the present invention, the electric harness 303 is placed in a mold 501 and a single core solid wire 502 is enclosed in the electric harness 303. The screw 503 along with a nut 504, provide a holding mechanism that holds the electric harness 303 at a distance of 3 mm from the mold 501. A spacer 505 is embedded along with the electric harness 303. Any other holding mechanism known in the art may be used.

In case the distance of the electric harness 303 is kept less than 3 mm from the mold face, the electric harness 303 becomes soft in shorter time by reaching heat distortion temperature and this is due to faster convection of heat to the electric harness structure. Also, the molten polymer does not flow completely around the electric harness 303 which is undesirable. Therefore, the electric harness material has to be selected such that the heat distortion temperature is more than the melting point of the polymer powder being introduced in the mold for making the structure. Accordingly, the distance to be maintained between the harness and the mold face needs to be optimal.

According to an exemplary embodiment of the invention, the ideal oven temperature for the proposed process is 300 degree Celsius and peak indoor air temperature (PIAT) inside the mold set is 220 degree Celsius. The PIAT is dependent on the size of the part being molded i.e., on the amount of polymer powder loaded inside the mold to get a specific thickness of the final molded part. The heating of the mold is controlled at 220 degree Celsius and is heated at various temperatures with a predefined time difference. The heat melts the powdered polymer inside the mold and time taken depends on the size of the part being molded and the weight of powdered polymer added inside the mold.

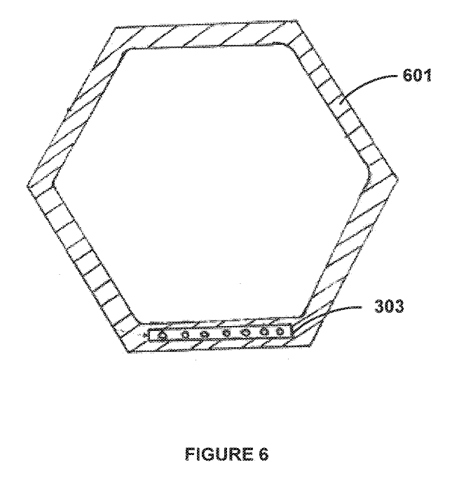

FIG. 6 illustrates an electric harness being embedded in the wall of structure, according to an embodiment of the present invention. On heating, the melted polymer 601 flows around the closed mold and when rotated will embed the electric harness 303. This process ensures that the electric harness 303 becomes an integral part of the structure. The electric harness 303 is not exposed to air at any length and will have no exposure to oxygen in the atmosphere. When the molded structure is painted the electric harness 303 is completely embedded inside the structure and cannot be seen from any side as the rotomolded structures are closed form all six sides.

The electric harness 303 is a single solid conductor which assists in better heat dissipation as the surface area of the electric harness 303 is more along with solid core wires. These solid core wires reduce the flexibility of the electric harness 303, which enables it to be held firmly at a distance from the mold face during the mold rotation.

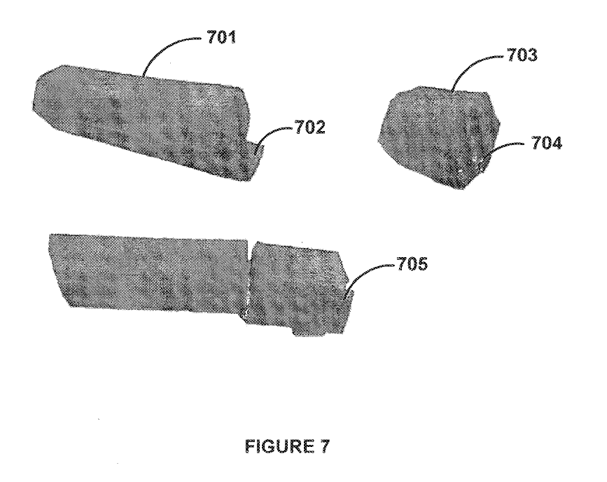

FIG. 7 illustrates assembling of modular structures, according to an embodiment of the present invention. The structures are modular in nature, wherein a structure so formed could be connected to other structures having preplanned connectors and wiring layout which is in continuum to the initial part. As illustrated in the figure, a first structure 701 with a connecting feature 702 that extends out and another second structure 703 with a connecting feature 704 bonds with the connecting feature 702 of the first structure 701 to form a structure 705. The representation shown in FIG. 7 is only an indication of how the modular structures could be connected. The assembling of the modular structures could be done in any way known in the art and does not limit to the above illustration.

Further, there could be static structures as well as dynamic structures. The two dynamic structures could be connected by simple knuckle type geometry which allows electrical connection between them. This reduces the time for assembly as the structures can be put together by having different male and female geometries on the interfacing structures. Thus, also creating an electrical connection between them which can have poka-yoke so that there cannot be a wrong way of connection.

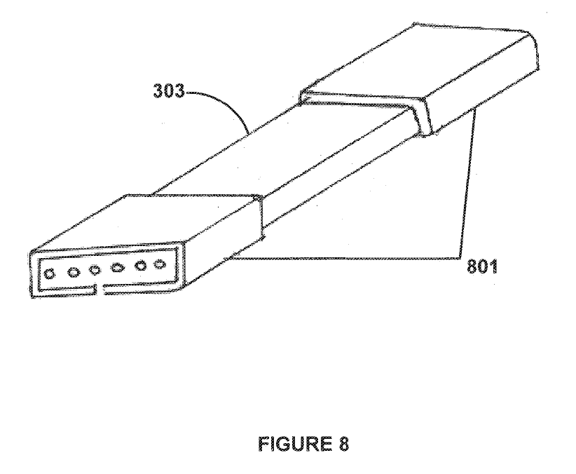

FIG. 8 illustrates an electric harness with a metal cover which is embedded at strategic locations in a structure, according to an embodiment of the present invention. In one embodiment, the electric harness 303 is made of any plastic or resin material that has a melting point above a melting point of polyethylene (PE) powder. Certain section of the electric harness 303 is covered with one or more metal covers 801. This ensures embedding of an electric harness (having very high melting point) with a metal cover, The molten PE powder flows over the electric harness 303 at places where it is covered by the metal cover 801 and does not flow over other areas of the electric harness 303 which is not covered by the metal cover 801. The metal cover 801 enclosing the electric harness, which may be communication cables, reduces noise effect during communication.

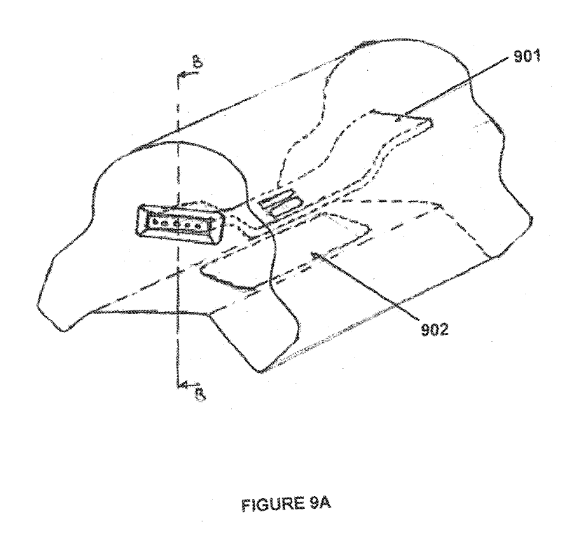

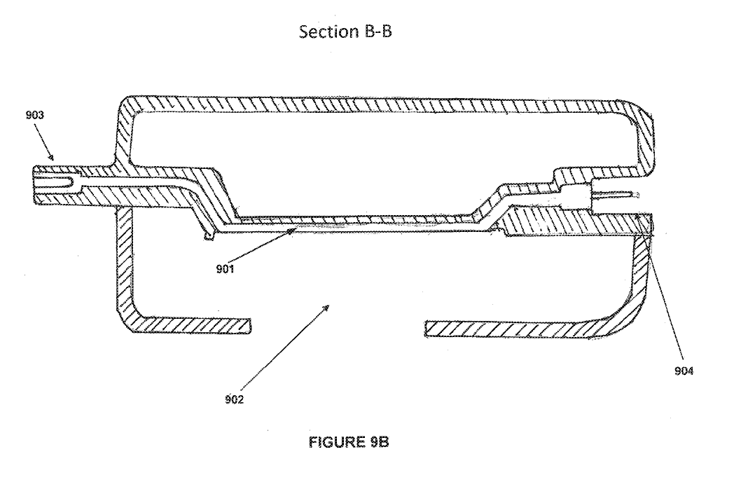

FIG. 9A illustrates modularity in connection of accessories or control devices to the electric harness, according to an embodiment of the present invention. The electric harness 901 has an access junction 902 enabling easy access to connections. The access junction 902 provides access to fuses, sensors logic or for devices to be connected to the electric harness. In one exemplary case, the access junction 902 allows the modular structures to have fuses embedded or built in the electric harness 901 that help in restricting overvoltage in the electric harness. In another exemplary case, separate ground terminal could also be routed through the electric harness so as to prevent any short circuit. The polyethylene (PE) is a good electric insulator and has shielding properties which provides a fire proof electric harness. Various other accessories and/or control devices maybe connected at the access junction, depending on the application.

FIG. 9B illustrates a sectional view of the modularity in connection of accessories or control devices to the electric harness, according to an embodiment of the present invention. In addition to the features disclosed in FIG. 9A, FIG. 9B describes the connecting features such as a first feature (i.e. male feature) 903 and a second feature (i.e. female feature) 904 for providing quick and easy assembly of modular structures according to an exemplary embodiment of the present invention. The shapes of the connecting features (903 & 904) shown in FIG. 9B are only an indication of how the connecting feature could be for assembling the modular structures. The assembling of the modular structures could be done using shapes of the connecting feature known in the art and does not limit to the above illustration.

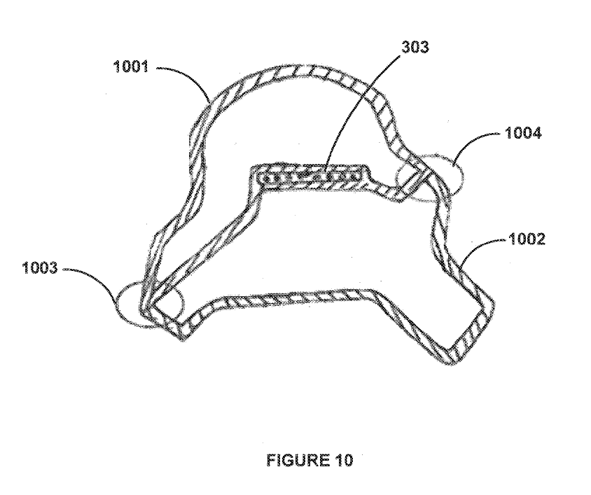

FIG. 10 illustrates cross-sectional view of a pillar designed to embed electric harness, according to an embodiment of the present invention. This embodiment describes a process for making the electric harness 303 stress free. The rotomolded structures are broadly classified as the ones which do not carry loads and the ones which carry loads. The structures which do not carry loads could have the electric harness 303 embedded in the wall which constitutes the external of the structure. As there will be no loading on the structure, the external wall and the electric harness 303 that is embedded in the wall will not undergo any strain.

Further, when the electric harness 303 is placed inside the structure it needs to be held at the center of the section i.e., at the neutral axis so that no strain is applied on the electric harness 303. The cross-sectional view as represented in the FIG. 10 is of an automotive structure, “A pillar” of an automotive. The electric harness 303 is embedded between a first material 1001 and a second material 1002 as shown in the figure. The point of intersection between the two materials 1001 and 1002 is only at corner edges 1003 and 1004 that run throughout the section length. This avoids the electric harness 303 from being stressed.

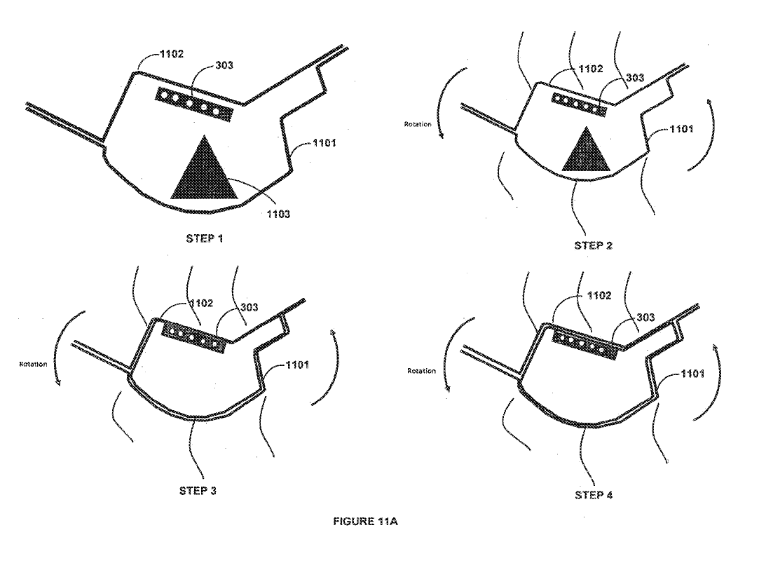

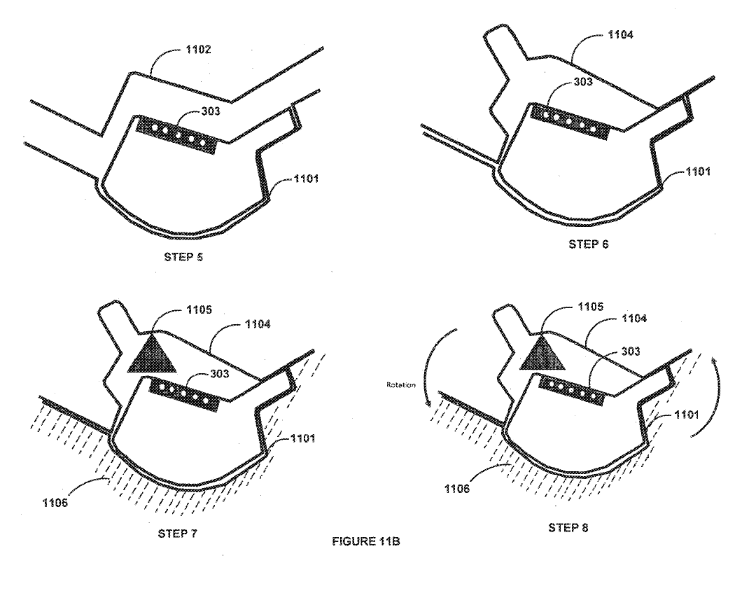

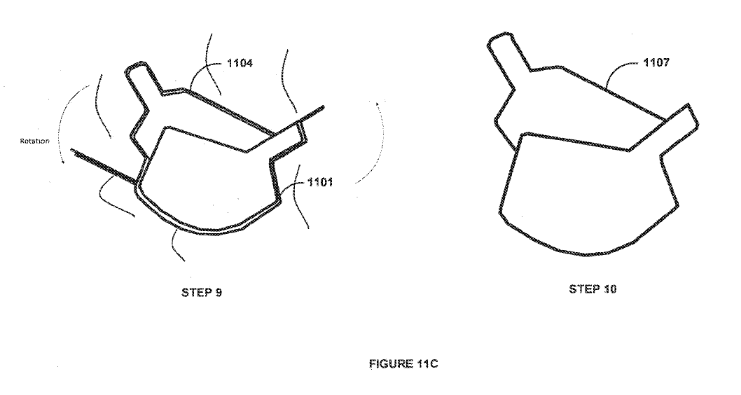

FIG. 11 illustrates a method of manufacturing integrated modular structure using rotomolding process, according to an embodiment of the present invention. According to the present invention, the process involves the following steps:

Step 1: The electric harness 303 is held in a first mold 1102 and a first material 1103 is introduced in powder form in a base mold 1101. The base mold 1101 and the first mold 1102 are attached in such a way forming an enclosure.

Step 2: The oven is heated at, for example, 300 degree Celsius and the mold set is rotated about two axes. The PIAT reaches 220 degree Celsius which is controlled by factors like heating time, quantity of material inside the mold set.

Step 3: The heating and rotation of the mold set allows the material to melt and flow in between the electric harness and the mold. It also causes the molten material to flow over the electric harness 303 to embed it. The gap at which the electric harness 303 is held from the mold plays an important role.

Step 4: The mold set is removed from the oven and cooling cycle is applied to the part so formed inside the mold set. This cooling cycle depends on size of the molded part.

Step 5: First mold 1102 is removed from the mold set after the molded part is cooled to a predefined temperature such as 80 degree Celsius. The temperature of the part should be such that it can fuse with the next second material of the trim which will be introduced.

Step 6: First mold 1102 is replaced with the second mold 1104. The second material 1105 gets introduced between the base mold 1101 and second mold 1104, when the previously molded part is still inside the base mold 1101. In one embodiment, the second material is same as the first material and in another embodiment the second material is different from the first material.

Step 7: Before starting the heating process of mold set, a shield 1106 is provided on the base mold 1101 to protect it from being exposed to the oven and heat. This shield 1106 on the base mold 1101 avoids melting of the formed molded part due to the heat applied. In one exemplary embodiment, thermoelectric device is stuck to the mold for providing shield to the base mold. The present invention is adapted to use any method/device known in the art for providing shielding.

Step 8: Heating of the mold set would heat the second mold 1104 and the second material 1105 that is in powdered form would melt. As the base mold 1101 is shielded, temperature is controlled and restricts melting of the first material 1103.

Step 9: The second material 1105 that is now in molten state flows in the mold and bind at the edge of the previously molded part which is in base mold 1101. The cooling cycle is then applied as per the size of the part formed. The nature of connection made between the first material 1103 and the second material 1105 is illustrated in FIG. 11.

Step 10: Final component 1107 with the embedded electric harness 303 along with the trim 1104 (i.e. second molded part 1104) in the structure is obtained. This forms the complete modular structure of the invention along with the integrated electric harness.

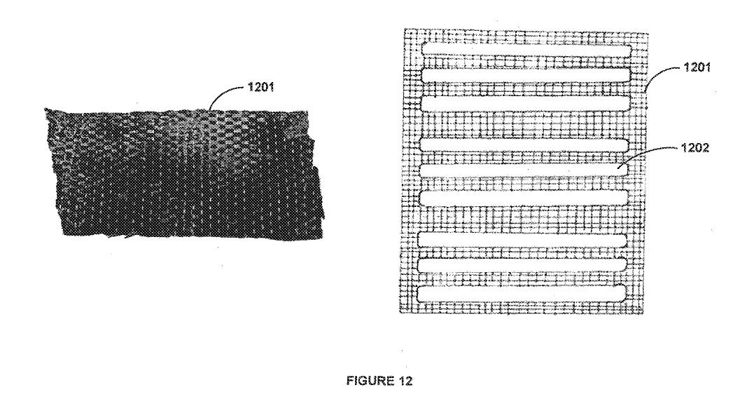

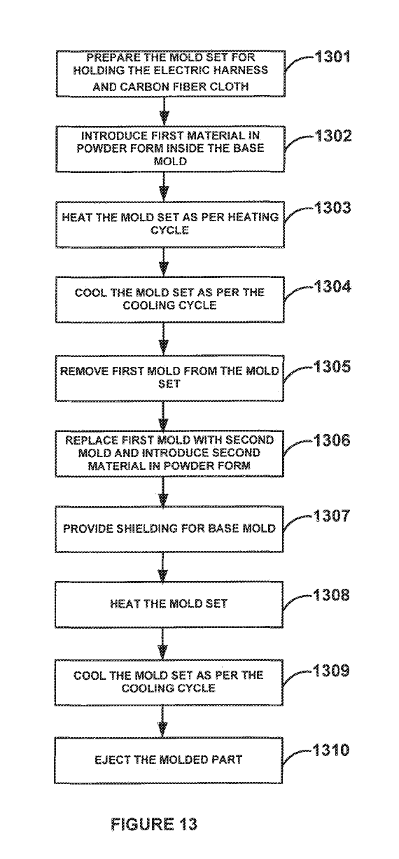

FIG. 12 illustrates a carbon fiber cloth 1201, according to an embodiment of the present invention. In one embodiment, the carbon fiber cloth 1201 is used to provide strength to the modular structure, which is achieved by a process of embedding carbon fiber cloth 1201 in the modular structure as explained in FIG. 13. The carbon fiber is woven into a cloth which has unidirectional or bidirectional strength depending on the weave pattern. This is used to control the amount of strength to be provided in a particular direction. The carbon fiber doth 1201 is provided with slots 1202 for the PE material to flow.

FIG. 13 illustrates a flow diagram for a method for manufacturing the integrated modular structure using rotomolding process, according to an embodiment of the present invention. At step 1301, prepare the mold set for holding the electric harness 303 and the carbon fiber cloth 1201. Once the electric harness 303 is placed inside the first mold, at step 1302, introduce a first material in powder form inside the base mold. After the first material is introduced, at step 1303, heat the mold set as per heating cycle. This melts the first material and allows the material to flow through out in order to embed the electric harness 303. At step 1304, cool the mold set as per the cooling cycle. When the molded part reaches approximately 80 degree Celsius, at step 1305, remove the first mold from the mold set. Further, at step 1306, replace the first mold with the second mold and introduce a second material in powder form between the second mold and the base mold. Before heating the mold set, at step 1307, provide shielding for base mold. At step 1308, heat the mold set. After heating, at step 1309, cool the mold set as per predefined cooling cycle. Finally, at step 1310, eject the molded part. The first material and second material may be same or different.

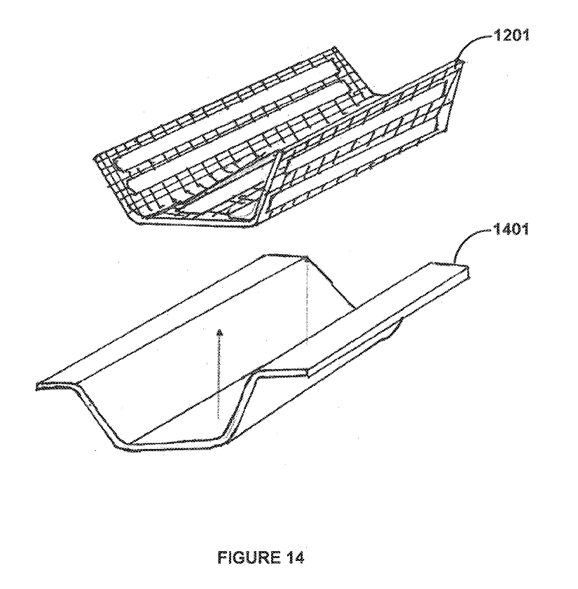

FIG. 14 illustrates a shape of tool to be replicated on the carbon fiber cloth 1201, according to an embodiment of the present invention. The carbon fiber cloth 1201 cannot be directly used in the rotomolding structure. To use the carbon fiber cloth 1201, it must be made stiff by applying a resin or a polymer so that it takes the shape of the surface 1401. After the carbon fiber cloth 1201 is made stiff according to the shape of a surface 1401, it is used in rotomolding structure to strengthen the same.

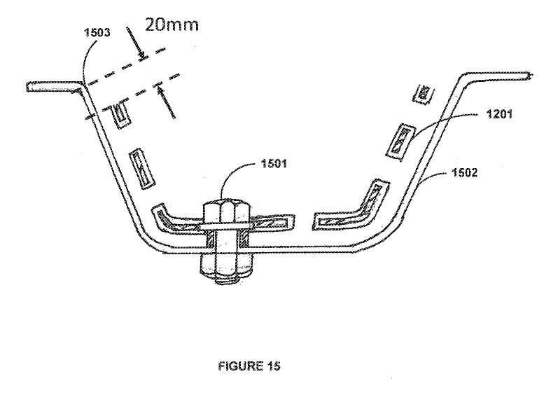

FIG. 15 illustrates a component of carbon fiber cloth (CFC) 1201 with a fastener 1501 that is held in the mold 1502, according to an embodiment of the present invention. The carbon fiber cloth 1201 could have fasteners 1501 such as plastic bolts, clips, nuts, etc. or other load transfer points fixed on it with precision. These fasteners 1501 help in placing the carbon fiber cloth 1201 in the mold 1502 in order to embed it inside the structure. This helps in achieving a very high positional accuracy because unlike sheet metal the process does not cause any spring back. In one exemplary embodiment, the CFC is placed at a distance of 20 mm from an edge 1503 of the mold wall.

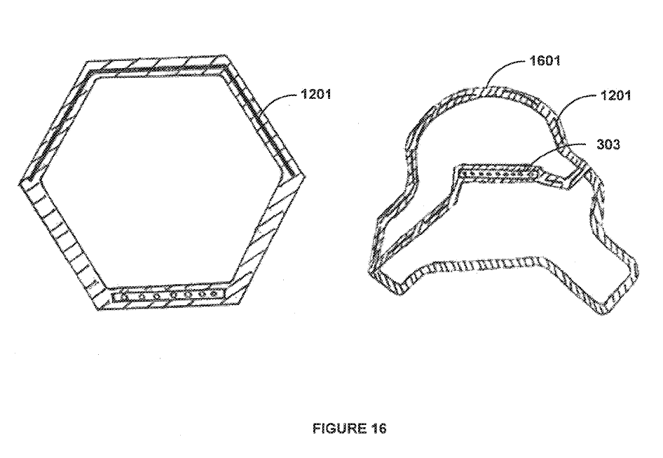

FIG. 16 illustrates a carbon fiber cloth 1201 embedded in the modular structure 1601, according to an embodiment of the present invention. According to the present invention, the carbon fiber cloth 1201 is embedded inside the structure 1601 and it need not have full surface area coverage to achieve strength. The carbon fiber cloth 1201 being stronger in tension than steel will only be required in the direction of load path. The amount of area left open in the carbon fiber cloth 1201 varies with the surface area of the part and may not be more than fifty percent of the area of the mold surface. This is because the powdered PE will require hot surface of the mold to melt into a plastic melt and if the major part of mold is covered by the CFC it will be difficult for the PE to reach all parts of the mold.

In one embodiment, the carbon fiber cloth 1201 should be maintained at a distance of minimum 20 mm from the edge of the mold wall. This distance mentioned is approximate and would dependent on geometry of mold and the application. The curing time for a resin would be dependent on type of resin being used to cure the CFC. The advantage of the process is that, the CFC is separated from the polymer of the part by heating the part above the melting point of the polymer. This makes the structure recyclable and the polymer could be reused for making new structures. It is to be noted that the carbon fiber cloth may or may not be embedded depending on the application requirement.

Although the exemplary embodiment has been for manufacturing rotomolded components for automotive, it is to be noted that the method of the invention may be extended for manufacturing modular rotomolded components for various applications. The other applications, for which the method of the invention may be used to create modular rotomolded structures, are, but not limited to, manufacturing cabinets, internal separators in building, airplane component, industrial components, etc. Thus, the method of the invention may be used for manufacturing rotomolded structure with an embedded electric harness for any application.

All equivalent relationships to those illustrated in the drawings and described in the invention are intended to be encompassed by the present invention. The examples used to illustrate the embodiments of the present invention, in no way limit the applicability of the present invention to them. It is to be noted that those with ordinary skill in the art will appreciate that various modifications and alternatives to the details could be developed in the light of the overall teachings of the disclosure, without departing from the scope of the invention. For example, the first material and the second material could be same or different. The temperatures mentioned are exemplary only and the optimal temperature required would be dependent on the application. The distance to be maintained between the electric harness and the mold wall would vary depending upon the application. The distance between the carbon fiber cloth and the mold wall edge would depend on the application. The width of the slots in the carbon fiber cloth would vary depending on the amount of requirement of strength of the modular structure.

What is claimed is:

1. A method of manufacturing an integrated modular structure using a rotomolding process, comprising:
placing at least one electric harness inside a mold set, wherein the mold set includes a base mold and a first mold joined together to form an enclosure;
introducing a first material in the base mold of the mold set;
heating and rotating the mold set to allow the first material to melt and flow over the at least one electric harness to embed the at least one electric harness in the first material and form a first molded part;
cooling the first molded part;
replacing the first mold of the mold set with a second mold;
introducing a second material between the base mold and the second mold with the first molded part in the base mold;
heating the mold set to melt the second material to form a second molded part; and
cooling the second molded part;
wherein the first molded part, the second molded part, and the at least one electric harness form an integrated modular structure.

2. The method of claim 1, wherein the at least one electric harness has a predefined length and width, and wherein placing the at least one electric harness inside the mold set comprises:
placing the at least one electric harness in the first mold; and
holding the at least one electric harness in the first mold at a predefined distance from a face of the first mold by a holding mechanism to allow the first material to flow between the at least one electric harness and the first mold.

3. The method of claim 2, wherein placing the at least one electric harness in the first mold at the predefined distance from a face of the first mold provides shielding to the at least one electric harness from heat.

4. The method of claim 2, wherein the at least one electric harness is located toward a center of the integrated modular structure.

5. The method of claim 1, wherein during heating the mold set to melt the second material, the base mold is shielded to restrict melting of the first material to allow the second material to flow in the mold set and bind at an edge of the first molded part.

6. The method of claim 1, wherein heating and rotating the mold set to allow the first material to melt and flow over the at least one electric harness includes heating to a peak indoor air temperature inside the mold set of 220 degrees Celsius.

7. The method of claim 1, wherein the at least one electric harness is provided with one or more metal covers at one or more sections of the at least one electric harness.

8. The method of claim 1, wherein the at least one electric harness includes an access junction.

9. The method of claim 1, wherein the integrated modular structure comprises one or more connecting features to enable assembly of one or more modular structures.

10. The method of claim 1, further comprising embedding a carbon fiber cloth in the base mold to strengthen the integrated modular structure, wherein embedding the carbon fiber cloth comprises:
preparing the carbon fiber cloth for the process of embedding;
placing the carbon fiber cloth on a predefined portion of the base mold in a direction of load; and
fixing the carbon fiber cloth in the base mold with a fixing mechanism.

11. The method of claim 10, wherein the carbon fiber cloth is provided with slots to allow for the first material to flow in the carbon fiber cloth.

12. The method of claim 1, wherein the at least one electric harness is made of a material having a melting point that is higher than the melting point of the first material.

13. The method of claim 1, wherein the second material is the same as the first material.

14. The method of claim 1, wherein the second material is different from the first material.
